(19) United States
(12) Patent Application Publication
(10) Pub. No.: US 2025/0127098 A1
(43) Pub. Date: Apr. 24, 2025

(54) CHASSIS FOR HOLDING FLUID DELIVERY DEVICES FOR TREE INJECTION SYSTEMS, AND USES THEREOF

(71) Applicant: Invalo Sciences Internatjional GmbH, Basel (CH)

(72) Inventors: Thomas GERSTER, Zwingen (CH); Marius LERF, Basel (CH); Benjamin MEIER, Reinach (CH); Beat MÜLLER, Kaiseraugst (CH); Michael Christian OEHL, Reinach (CH); Pascal TROMMENSCHLAGER, Masevaux-Niederbruck (FR); Urs WIDMER, Dornach (CH)

(73) Assignee: Invalo Sciences Internatjional GmbH, Basel (CH)

(21) Appl. No.: 18/570,011

(22) PCT Filed: Jun. 15, 2022
(86) PCT No.: PCT/IB2022/055535

§ 371 Date: Dec. 13, 2023

Related U.S. Application Data
(60) Provisional application No. 63/202,539, filed on Jun. 15, 2021.

(51) Int. Cl. A01G 7/06

(52) U.S. Cl. CPC A01G 7/06

(57) ABSTRACT

Provided herein are chassis (100, 200, 322, 400, 500, 600) for positioning and mounting a fluid delivery device onto a plant to distribute a liquid formulation to the plant, and the method of using the chassis (100, 200, 322, 400, 500, 600)

### CROSS-REFERENCE TO RELATED APPLICATIONS

This application claims priority to and the benefit of U.S. Provisional Application No. 63/202,539, filed on Jun. 15, 2021, the disclosure of which is incorporated herein by reference in its entirety.

### FIELD

The present disclosure relates generally to devices and methods for administering liquid formulations to plants, and more specifically to chassis for positioning and mounting a fluid delivery device onto a plant to distribute a liquid formulation including one or more active ingredients to the plant, and the method of using the chassis.

### BACKGROUND

Plant injection has been used for administration of active ingredients to plants. Conventional plant injection approaches can involve drilling a borehole in a tree trunk and stoppering the borehole with a peg. A needle is inserted through the peg to discharge liquid into the borehole.

There exists a need in the art for a commercially suitable chassis for positioning and mounting fluid delivery devices such as pressurized canisters containing liquid formulations that has the appropriate design features (e.g., in terms of rigidity, stability, flexibility) over extended periods of time and through various temperature cycles (e.g., seasonal and diurnal) that can administer active ingredient through injection tools to the plant.

### BRIEF SUMMARY

In some aspects, described herein are chassis configured to position and mount a fluid delivery device onto a plant part, plant injection systems comprising the chassis, and methods for positioning and mounting or using the chassis.

In one aspect, provided is a chassis configured to position and mount a fluid delivery device onto a plant part. In some embodiments, the fluid delivery device comprises a nozzle and contains a liquid formulation. In some variations, the chassis comprises: a main frame, a top element, and a base element. In some variations, the main frame is connected on one end to the top element and connected on the other end to the base element. In some variations, the main frame has a bottom surface and a top surface. In some variations, the main frame comprises at least one penetrating element configured to at least partially penetrate into the plant part. In some variations, the top surface of the main frame comprises at least one strike zone configured to receive a force exerted along a penetrating direction sufficient to cause the at least one penetrating element to at least partially penetrate into the plant part along the penetration direction. In some variations, the top surface is further configured to receive the fluid delivery device. In some variations, the top element comprises a top opening. In some variations, the top opening is configured to receive an adapter for interfacing with the nozzle of the fluid delivery device. In some variations, the base element is configured to come into contact with the bottom of the fluid delivery device.

In some embodiments, when the fluid delivery device is positioned between the top element and the base element of the chassis, the top element and the base element exert opposite forces to hold the fluid delivery device in position within the chassis. In some embodiments, when the fluid delivery device is positioned between the top element and the base element of the chassis, the nozzle of the fluid delivery device is in contact with the adapter held in position by the top element. In some embodiments, the chassis exerts a pressure on the nozzle to release the liquid formulation through the nozzle.

In some embodiments, the chassis is made from a material that has one or more of the following properties: (i) flexibility to allow insertion of the adapter and the liquid delivery device between the top element and the base element; (ii) rigidity to hold the liquid delivery device in between the top element and the base element and to trigger release of the liquid formulation from the liquid delivery device; (iii) resistance to moisture such that the chassis experiences little to no deformation upon prolonged exposure to moisture; (iv) resistance to corrosion such that the chassis experiences little to no rust over time and usage; (v) inertness such that the chassis does not release any metal ions, or any substantial amount of metal ions, into the environment; or (vi) formability such that the chassis, if damaged and/or deformed, can easily be repaired by bending the chassis back to its original position; or any combination of the foregoing. In some embodiments, the material comprises metal, plastic, or a combination thereof. In some embodiments, the material comprises stainless steel. In some embodiments, the material comprises reinforced plastic.

In some embodiments, the minimum safety factor of the chassis is at least 1. In some embodiments, the minimum safety factor of the chassis is between about 1 and about 5. In some embodiments, the maximum displacement of the chassis with a rotational constraint at the base element and a linear force of about 30 N at the top element is less than about 0.5 mm. In some embodiments, the maximum displacement of the chassis with a rotational constraint at the base element and a linear force of about 30 N at the top element is between about 0.01 mm and about 0.025 mm.

In some embodiments, the chassis is in loaded state when the adapter is inserted in the top opening and the liquid delivery device is inserted between the adapter and the base element. In some embodiments, the chassis is in unloaded state when the liquid delivery device is not inserted between the adapter and the base element. In some embodiments, the displacement of the top element and the displacement of the base element between the loaded state and the unloaded state are small enough to trigger release of the liquid formulation from the liquid delivery device. In some embodiments, the sum of the displacement of the top element and the displacement of the base element between the loaded state and the unloaded state is less than 0.05 mm.

In some embodiments, the main frame comprises four penetrating elements. In some embodiments, first and second penetrating elements are positioned near the top element, and third and fourth penetrating elements are positioned near the base element.

In some embodiments, the top surface of the main frame comprises two strike zones. In some embodiments, first strike zone is positioned near the top element, and second strike zone is position near the base element.

In some embodiments, the adapter is connected to an injection tool through a tubing. In some embodiments, the penetrating direction is substantially perpendicular to the bottom surface and the top surface of the main frame. In some embodiments, the main frame further comprises one or more side openings. In some embodiments, the one or more side openings are configured to receive one or more fastening elements such that the chassis can be fixed onto the plant part with the one or more fastening elements. In some embodiments, the one or more fastening elements are wire, rope, thread, cloth, band, belt, or fiber, or any combination thereof.

In another aspect, described herein are plant injection systems. In some embodiments, the plant injection system comprises a fluid delivery device. In some variations, the fluid delivery device comprises a nozzle and contains a liquid formulation. In some variations, the plant injection system comprises a chassis described herein, configured to position and mount the fluid delivery device onto a plant part. In some variations, the plant injection system comprises an injection tool. In some variations, the injection tool is operatively connected to the fluid delivery device and configured to receive the liquid formulation from the fluid delivery device and to release the liquid formulation into the plant part.

In some embodiments, the fluid delivery device is a pressurized canister. In some embodiments, the liquid formulation comprises one or more active ingredients. In some embodiments, the injection tool releases the liquid formulation into the active vasculature of the plant part. In some embodiments, the system further comprises an adapter for interfacing with the nozzle of the fluid delivery device. In some embodiments, the system further comprises a tubing configured to connect to the injection tool on one end and to the adapter on the other end.

In some aspects, provided herein are methods for positioning and mounting a chassis described herein on to a plant part. In some embodiments, the method comprises positioning the chassis against the plant part. In some variations, the method comprises exerting a force on the at least one strike zone of the chassis to at least partially insert the at least one penetrating element into the plant part. In some variations, the method comprises fixing the chassis onto the plant part using one or more fastening elements.

In some embodiments, the method comprises mounting a fluid delivery device onto the chassis. In some embodiments, the fluid delivery device comprises a nozzle and contains a liquid formulation. In some embodiments, the method comprises connecting the adapter inserted in the top opening of the top element of the chassis with the nozzle of the fluid delivery device.

In other aspects, provided herein are methods of using the chassis described herein. In some embodiments, the method comprises inserting an injection tool into the plant part. In some variations, the injection tool is connected to one end of a tubing, and the other end of the tubing is connected to the adapter. In some variations, the method comprises inserting the adapter in the top opening of the top element of the chassis, thereby forming a light fit between the adapter and the top element of the chassis. In some variations, the method comprises inserting the at least one penetrating element into the plant part. In some variations, the method comprises inserting the fluid delivery device between the adapter and the base element of the chassis. In some variations, the method comprises fixing the chassis onto the plant part using the one or more fastening elements.

In some embodiments, inserting the at least one penetrating element into the plant part comprises striking the at least one strike zone of the chassis with a hammer. In some embodiments, inserting the fluid delivery device between the adapter and the base element of the chassis comprises connecting the adapter with the nozzle of the fluid delivery device. In some embodiments, the plant part comprises bark. In some embodiments, the bark has a thickness of at least 3 mm. In some embodiments, fixing the chassis onto the plant part using the one or more fastening elements comprises passing a wire through the one or more side openings and around the plant part.

### DESCRIPTION OF THE FIGURES

The present application can be understood by reference to the following description taken in conjunction with the accompanying figures.

FIG. 1 depicts an exemplary chassis suitable for positioning and mounting a fluid delivery device (e.g., a pressurized canister) onto a plant part (e.g., a trunk of a tree).

FIGS. 2A-2C depict a front view, a side view, and a planar view, respectively, of an exemplary chassis. FIG. 2D depicts a side view of the exemplary chassis to illustrate the displacement of the chassis when it is holding a liquid delivery device.

FIGS. 3A-3D depict a series of figures showing steps for installing exemplary chassis into the trunk of a tree.

FIGS. 4A-4C depict a front view, a side view, and a top view, respectively, of an exemplary chassis.

FIG. 5 depicts an exemplary chassis from various angles.

FIG. 6 depicts an exemplary chassis from various angles.

FIGS. 7A and 7B each depicts exemplary chassis for finite element analysis.

### DETAILED DESCRIPTION

The following description sets forth exemplary systems, methods, parameters and the like. It should be recognized, however, that such description is not intended as a limitation on the scope of the present disclosure but is instead provided as a description of exemplary embodiments.

### Chassis

In some aspects, provided is a chassis suitable for positioning and mounting a fluid delivery device (e.g., a pressurized canister) containing a liquid formulation onto a plant part (e.g., a trunk of a tree). In some embodiments, the liquid delivery device is connected to an injection tool (such as an injection tip) inserted into the trunk of the tree, and the liquid delivery device is configured to feed a liquid formulation comprising one or more active ingredients over time through the injection tool into the tree.

In some embodiments, the chassis is configured to position and mount a fluid delivery device onto a plant part such as a tree trunk, wherein the fluid delivery device comprises a nozzle and contains a liquid formulation. In some variations, the chassis comprises a main frame, a top element, and a base element. In some variations, the main frame is connected on one end to the top element and connected on the other end to the base element. In some variations, the main frame has a bottom surface and a top surface. In some variations, the main frame comprises at least one penetrating element configured to at least partially penetrate into the plant part. In some variations, the top surface of the main frame comprises at least one strike zone configured to receive a force exerted along a penetrating direction sufficient to cause the at least one penetrating element to at least partially penetrate into the plant part along the penetration direction. In some variations, the top surface is further configured to receive the fluid delivery device. In some variations, the top element comprises a top opening configured to receive an adapter for interfacing with the nozzle of the fluid delivery device. In some variations, the base element is configured to come into contact with the bottom of the fluid delivery device.

In some embodiments, when the chassis is mounted onto the plant part, the bottom surface of the main frame faces the plant part. In some variations, the adapter can be inserted into the top opening of the top element to be reversibly fixed. In some variations, the shape of the top opening is complementary to the shape of the adapter such that the adapter can be inserted into the top opening to form a light fit between the adapter and the top opening. In some variations, the top opening has a C-shape.

In some embodiments, when the fluid delivery device is positioned between the top element and the base element of the chassis, the top element and the base element exert opposite forces to hold the fluid delivery device in position within the chassis. In some variations, the nozzle of the fluid delivery device is in contact with the adapter held in position by the top element. In some variations, the chassis exerts a pressure on the nozzle to release the liquid formulation through the nozzle.

With reference to FIG. 1, exemplary chassis 100 and exemplary adapter 190 are depicted. Chassis 100 comprises main frame 110, top element 120, and base element 130. Main frame 110 comprises top surface 112, bottom surface 114, side openings 116 and 140, and penetrating elements 144 and 148.

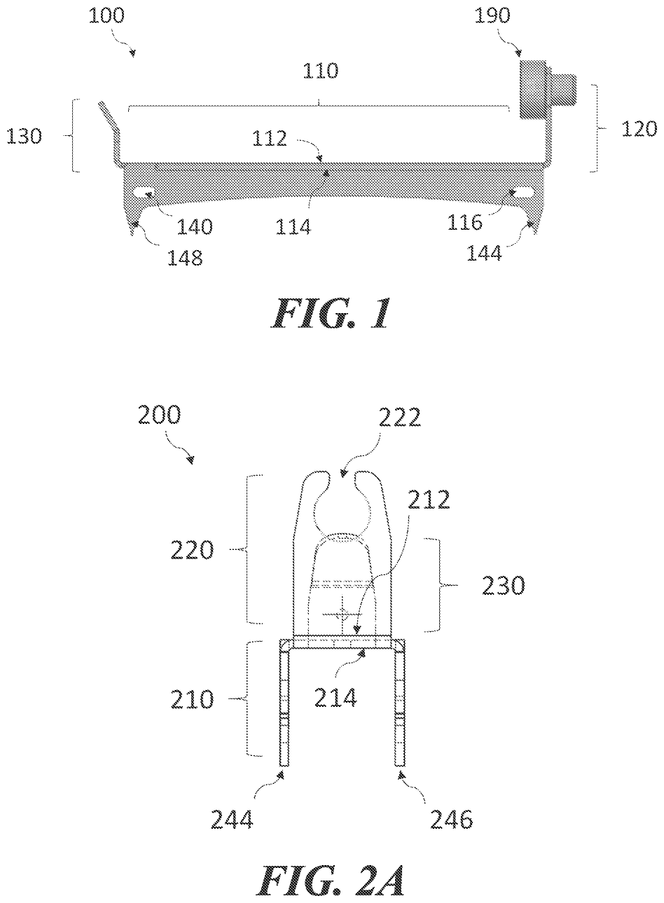

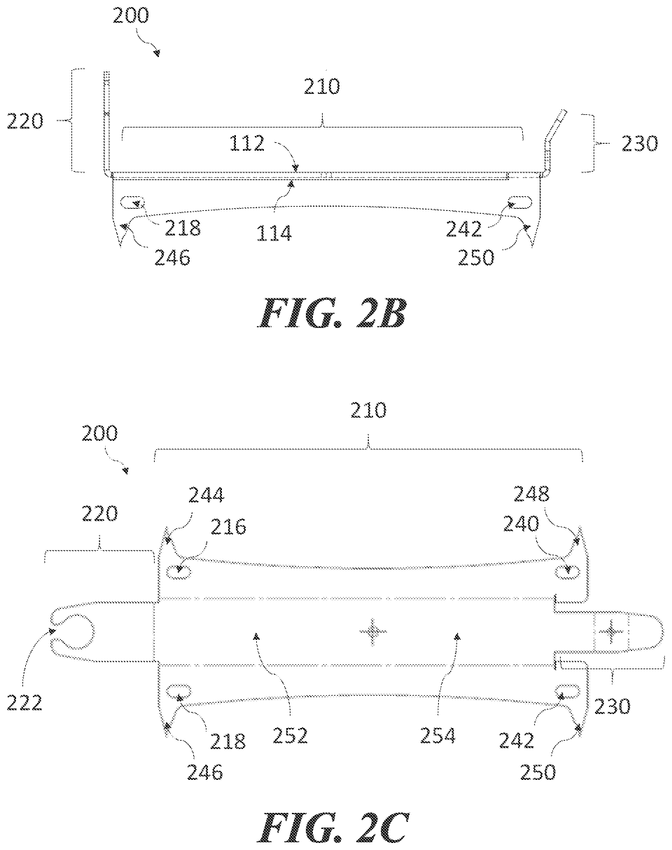

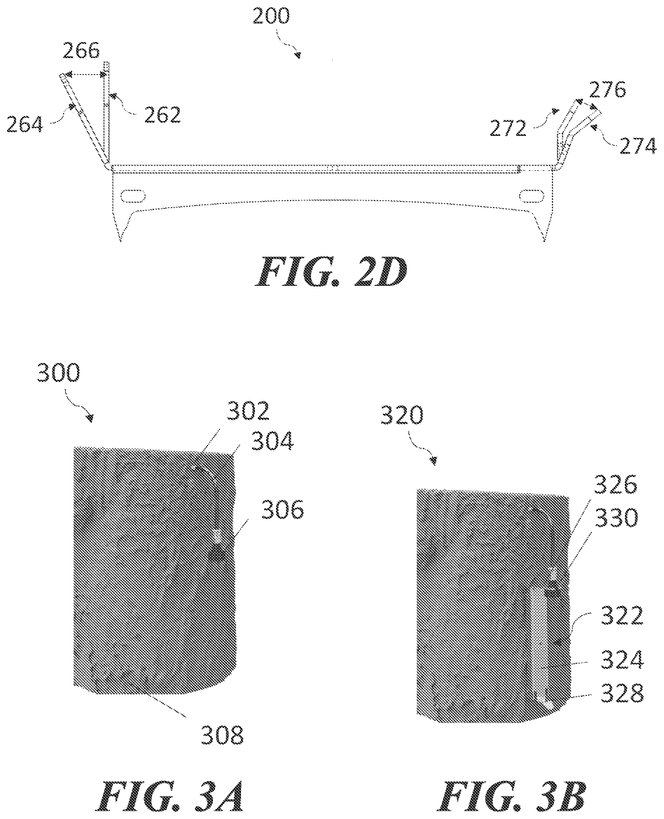

With reference to FIG. 2A, front view of exemplary chassis 200 is depicted. Chassis 200 comprises main frame 210, top element 220, and base element 230 (drawn in dashed lines behind top element 220). Main frame 210 comprises top surface 212, bottom surface 214, and penetrating elements 244 and 246.

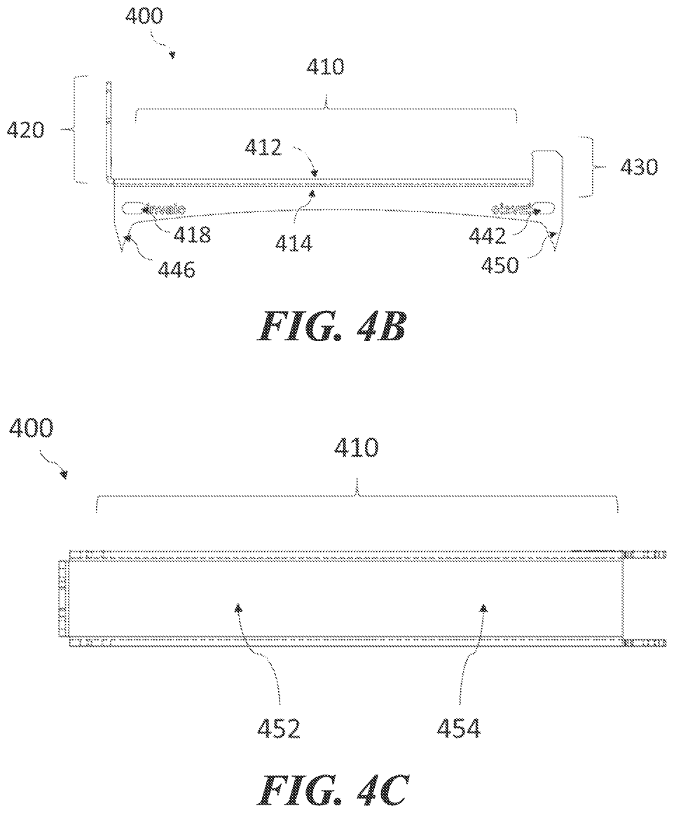

With reference to FIG. 4A, front view of exemplary chassis 400 is depicted. Chassis 400 comprises main frame 410, top element 420, and a base element (not shown). Main frame 410 comprises top surface 412, bottom surface 414, and penetrating elements 444 and 446.

With reference to FIG. 2B, side view of exemplary chassis 200 is depicted. Chassis 200 comprises main frame 210, top element 220, and base element 230. Main frame 210 comprises top surface 212, bottom surface 214, side openings 218 and 242, and penetrating elements 246 and 250.

With reference to FIG. 4B, side view of exemplary chassis 400 is depicted. Chassis 400 comprises main frame 410, top element 420, and base element 430. Main frame 410 comprises top surface 412, bottom surface 414, side openings 418 and 442, and penetrating elements 446 and 450.

With reference to FIG. 2C, planar figure of exemplary chassis 200 is depicted. Chassis 200 comprises main frame 210, top element 220, and base element 230. Main frame 210 comprises: first and second penetrating elements 244 and 246 near top element 220; third and fourth penetrating elements 248 and 250 near base element 230; strike zones 252 and 254, and side openings 216, 218, 240, and 242. Top element 220 comprises top opening 222.

With reference to FIG. 4C, planar figure of exemplary chassis 400 is depicted. Chassis 400 comprises main frame 410, which comprises strike zones 452 and 454.

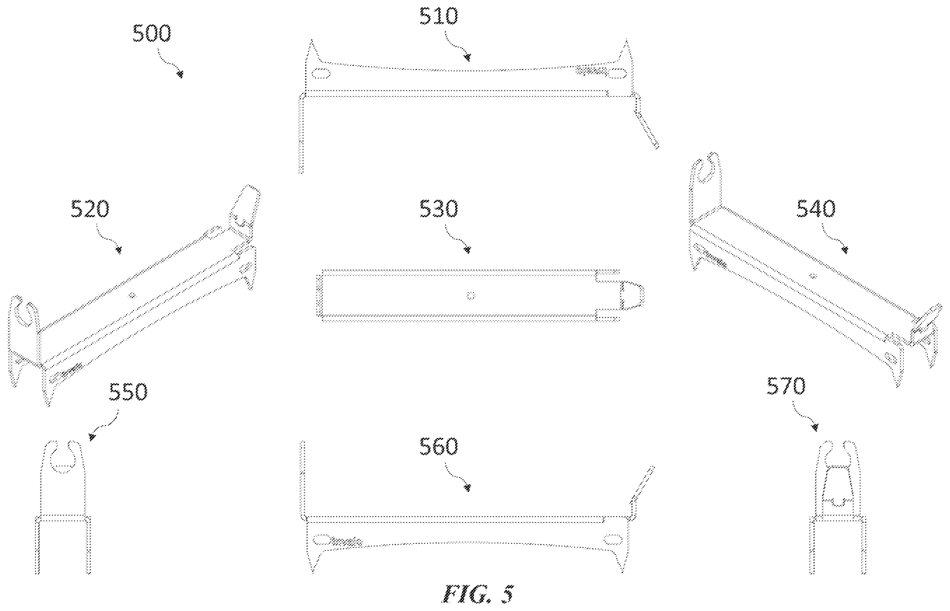

With reference to FIG. 5, exemplary chassis 500 is shown from the right side (510), left side (560), from the top (530), from the top element to the base element (550), from the base element to the top element (570), and in perspective views (520 and 540).

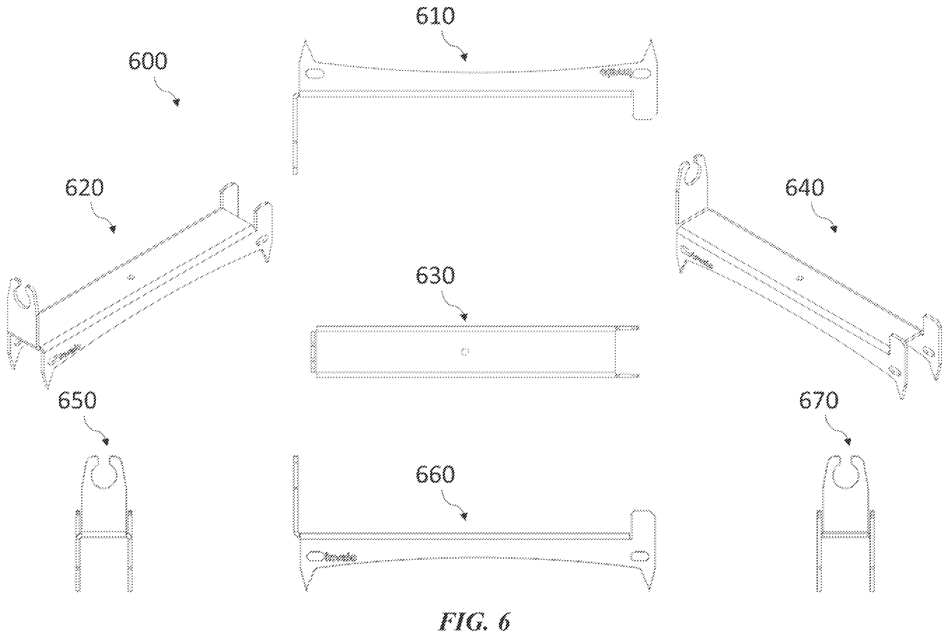

With reference to FIG. 6, exemplary chassis 600 is shown from the right side (610), left side (660), from the top (630), from the top element to the base element (650), from the base element to the top element (670), and in perspective views (620 and 640).

In some embodiments, the main frame comprises four penetrating elements. In some variations, two of the penetrating elements (first and second penetrating elements) are positioned near the top element, and the other two penetrating elements (third and fourth penetrating elements) are positioned near the base element.

In some embodiments, the top surface of the main frame comprises two strike zones, wherein first strike zone is positioned near the top element, and second strike zone is position near the base element.

In some embodiments, the adapter is connected to an injection tool through a tubing.

In some embodiments, the penetrating direction is substantially perpendicular to the bottom surface and the top surface of the main frame.

In some embodiments, the main frame further comprises one or more side openings. In some variations, the one or more side openings are configured to receive one or more fastening elements such that the chassis can be fixed onto the plant part with the one or more fastening elements. In some variations, the one or more fastening elements are wire, rope, thread, cloth, band, belt, or fiber, or any combination thereof.

In some embodiments, the chassis is flexible enough to allow insertion of the adapter and the liquid delivery device between the top element and the base element, yet rigid, stable, and/or elastic enough to exert sufficient force to hold the liquid delivery device in between the top element and the base element, and to trigger release of liquid formulation from the liquid delivery device. In some variations, the delivery device suitable for use with the chassis comprises an actuator such that when the top element and/or the base element exert forces to the actuator, the nozzle of the liquid delivery device is opened and the liquid formulation inside the liquid delivery device is released. In some variations, the delivery device comprises a pressurizing element that pushes the liquid formulation out of the delivery device when the nozzle is open.

In some embodiments, the chassis generally stays in an elastic deformation under normal usage, such that the chassis experiences little to no wear at all. In some variations, the chassis maintains its shape and structure over prolonged exposure to environmental conditions, including, for example, over one or more seasons. In certain variations, the chassis is made from one or more materials that absorb little or no water, and/or does not significantly change or expand in size with changes in environmental conditions. In some variations, any changes (if any) in the dimensions of the chassis (e.g., the change in the length of the main frame and/or the distance between the top element and the base element) due to prolonged exposure to environmental conditions do not operatively change how the chassis performs, e.g., in terms of the chassis exerting force onto the liquid delivery device to trigger release of the liquid formulation when the adapter is inserted in the top opening of the chassis and the liquid delivery device is inserted between the adapter and the base element. In some variations, the change in the length of the main frame and/or the distance between the top element and the base element after prolonged exposure to humidity is less than 0.1%, less than 0.2%, less than 0.3%, less than 0.4%, less than 0.5%, less than 1%, less than 2%, less than 3%, less than 4%, less than 5%, less than 10%, less than 20%, or less than 30%.

In some embodiments, the chassis comprises material that has a melting point much higher than ambient temperature or the temperature in which the chassis is used or operates. In some variations, the chassis comprises material that has a melting point of higher than 500° C., higher than 1000° C., higher than 1500° C., higher than 2000° C., higher than 2500° C., higher than 3000° C., between 500° C. and 3000° C., between 1000° C. and 2000° C., between 1250° C. and 1750° C., between 1400° C. and 1600° C., between 1450° C. and 1550° C., between 1500° C. and 1520° C., between 1505° C. and 1515° C., or around 1510° C. In one variation, the chassis comprises stainless steel having a melting point of 1510° C. In some variations, although the chassis may become softer with increasing temperature, under normal operating conditions, the change in softness of the chassis is negligible and/or not measurable.

In some embodiments, the chassis can be in a loaded state and an unloaded state. In some embodiments, the chassis is in loaded state when the adapter is inserted in the top opening and the liquid delivery device is inserted between the adapter and the base element. In some variations, the chassis is in unloaded state when the liquid delivery device is not inserted between the adapter and the base element. In some variations, the displacement of the top element (top displacement) and the displacement of the base element (base displacement) between the loaded state and the unloaded state are small enough to trigger release of the liquid formulation from the liquid delivery device. In some variations, the sum of the top displacement and the base displacement between the loaded state and the unloaded state is small enough to trigger release of the liquid formulation from the liquid delivery device. In some variations, the sum of the top displacement and the base displacement between the loaded state and the unloaded state is less than 0.05 mm. In some variations, the sum of the top displacement and the base displacement between the loaded state and the unloaded state is less than 0.01 mm, less than 0.02 mm, less than 0.03 mm, less than 0.04 mm, less than 0.05 mm, less than 0.06 mm, less than 0.07 mm, less than 0.08 mm, less than 0.09 mm, less than 0.1 mm, less than 0.12 mm, less than 0.14 mm, less than 0.16 mm, less than 0.18 mm, less than 0.2 mm, less than 0.25 mm, less than 0.3 mm, less than 0.4 mm, less than 0.5 mm, less than 1 mm, less than 1.5 mm, less than 2 mm, less than 5 mm, or less than 10 mm. In some embodiments, the sum of the top displacement and the base displacement between the loaded state and the unloaded state is the change in the distance between the top element and the base element when the chassis is in the loaded state compared to the unloaded state.

In some variations, the top displacement is the displacement of the top element between the loaded state and the unloaded state of the chassis. In some variations, the base displacement is the displacement of the base element between the loaded state and the unloaded state of the chassis. In some variations, the top displacement is measured as the shortest distance between the top element in the unloaded state and the end of the top element (or the part of the top element that is maximally displaced) in the loaded state. In some variations, the base displacement is measured as the shortest distance between the base element in the unloaded state and end of the base element (or the part of the base element that is maximally displaced) in the loaded state.

In some embodiments, the total displacement refers to the maximum difference of distance that the body deforms from an unloaded state to a loaded state. In some variations, the total displacement of the chassis between the unloaded state and the loaded state is less than 0.01 mm, less than 0.02 mm, less than 0.03 mm, less than 0.04 mm, less than 0.05 mm, less than 0.06 mm, less than 0.07 mm, less than 0.08 mm, less than 0.09 mm, less than 0.1 mm, less than 0.12 mm, less than 0.14 mm, less than 0.16 mm, less than 0.18 mm, less than 0.2 mm, less than 0.25 mm, less than 0.3 mm, less than 0.4 mm, less than 0.5 mm, less than 1 mm, less than 1.5 mm, less than 2 mm, less than 5 mm, or less than 10 mm.

With reference to FIG. 2D, side view of exemplary chassis 200 is depicted to illustrate the displacement of the top element and the base element when the chassis is in the loaded state. Top element 262 and base element 272 are in the unloaded state. Top element 264 and base element 274 are in the loaded state (the adapter and the liquid delivery device are not shown for clarity of the illustration; the degree of displacement in the figure may be exaggerated or different than that in actual operation of the chassis). Top displacement 266 indicates the displacement of the top element when the chassis is bound to an adapter and a liquid delivery device. Base displacement 276 indicates the displacement of the base element when the chassis is bound to an adapter and a liquid delivery device.

In some embodiments, the chassis has a total maximum displacement small enough to trigger release of the liquid formulation from the fluid delivery device in the loaded state. In some embodiments, the maximum displacement is estimated with a finite element analysis. In some embodiments, the maximum displacement is estimated with a finite element analysis with a rotational constraint at the base element of the chassis and a linear force of about 30 N at the top element of the chassis. In some embodiments, the maximum displacement is the maximum displacement of the top element. In some embodiments, the maximum displacement is less than about 0.5 mm. In some embodiments, the maximum displacement is less than about 0.7, 0.6, 0.5, 0.4, 0.3, 0.2, 0.1, 0.05, 0.04, 0.03, 0.025, 0.02, 0.015, or 0.01 mm. In some embodiments, the maximum displacement is between about 0.01 mm and about 0.025 mm. In some embodiments, the maximum displacement is between about 0.01 mm and about 0.5 mm, between about 0.01 mm and about 0.1 mm, or between about 0.01 mm and about 0.025 mm.

In some embodiments, the displacement is measured with respect to the main frame. In some embodiments, the displacement is measured with respect to the center of the main frame. In some embodiments, the displacement is measured with respect to the base element.

In some embodiments, the chassis has a minimum safety factor sufficient for operating in the loaded state, or positioning and mounting a fluid delivery device onto a plant part. In some variations, “safety factor” is the ratio of a system or body's strength to an expected strain or load. In some variations, “minimum safety factor” refers to the safety factor on the most stressed and/or critical part of the system or body. The minimum safety factor can be useful to check whether the chassis under normal usage can hold the intended stress. For example, in certain embodiments, if the minimum safety factor is below 1, the part may experience deformation and get damaged under the intended stress. In some embodiments, the minimum safety factor of the chassis is at least 3.5. In some embodiments, the minimum safety factor of the chassis is at least 1. In some variations, the minimum safety factor of the chassis is between about 1 and about 5. In some variations, the minimum safety factor is estimated with a finite element analysis. In some variations, the minimum safety factor of the chassis is at least 1, at least 1.5, at least 2, at least 2.5, at least 3, at least 3.5, at least 3.6, at least 3.7, at least 3.8, at least 3.9, at least 4, at least 4.5, at least 5, at least 10, or at least 15. In some variations, the minimum safety factor of the chassis is between about 1 and about 15, between about 1 and about 10, between about 1 and about 5, between about 2 and about 5, between about 3 and about 5, between about 3 and about 4, or between about 3.5 and about 4.

In some embodiments, the strike zone of the chassis is stable enough to withstand an exerted force (e.g., via hits by a hammer) to insert the chassis into a plant part. In some variations, the strike zone of the chassis is stable enough to withstand an exerted force of between 1 psi and 10,000 psi, between 100 psi and 10,000 psi, or between 1000 psi and 10,000 psi.

In some embodiments, the chassis defines a strike channel leading to the strike zone, the strike channel having an un-obstructed path configured to allow a hammer to travel to the strike zone. Strike zone and strike channel dimensions will vary from embodiment to embodiment. In some variations, typical strike zones may have a width in the range of 1.5 cm to 15 cm, and a height in the range of 1.5 cm to 30 cm. In certain embodiments, strike zones will have a width of about 2 cm to 5 cm and a height of at about 2 cm to 10 cm. Typical strike channels with have a width and a height corresponding to the strike zone of the particular embodiment and will have a length L defined at least in part by the top element.

In some embodiments, the chassis comprises a material that has one or more of the following properties: (i) flexibility to allow insertion of the adapter and the liquid delivery device between the top element and the base element; (ii) rigidity to hold the liquid delivery device in between the top element and the base element and to trigger release of the liquid formulation from the liquid delivery device; (iii) resistance to moisture such that the chassis experiences little to no deformation upon prolonged exposure to moisture; (iv) resistance to corrosion such that the chassis experiences little to no rust over time and usage; (v) inertness such that the chassis does not release any metal ions, or any substantial amount of metal ions, into the environment; or (vi) formability such that the chassis, if damaged and/or deformed, can easily be repaired by bending the chassis back to its original position; or any combination of the foregoing.

In some variations, the material comprises metal. In some variations, the material comprises stainless steel. In some embodiments, the material comprises plastic. In some embodiments, the material comprises reinforced plastic. In some embodiments, the material comprises plastic reinforced with glass or carbon fiber. In some embodiments, the material comprises reinforced polyamide. In some embodiments, the material comprises polyamide reinforced with glass or carbon fiber. In some embodiments, the material comprises a combination of any of the foregoing.

### Installation and Use of Chassis

In some aspect, described herein are methods for positioning and mounting the chassis onto a plant part. In some embodiments, the method comprises positioning the chassis against the plant part; and exerting a force on the at least one strike zone of the chassis to at least partially insert the at least one penetrating element into the plant part. In some variations, the method further comprises fixing the chassis onto the plant part using one or more fastening elements. Once installed, the fluid delivery device may be mounted onto the chassis.

In some embodiments, the plant part comprises a bark. In some variations, the method comprises exerting a force on the at least one strike zone of the chassis to at least partially insert the at least one penetrating element into the plant part when the bark has a thickness of at least 1 mm, at least 2 mm, at least 3 mm, at least 4 mm, at least 5 mm, at least 6 mm, at least 7 mm, at least 8 mm, at least 9 mm, at least 10 mm, at least 15 mm, or at least 20 mm. In some embodiments, the method comprises fixing the chassis onto the plant part using one or more fastening elements when the bark has a thickness of less than 1 mm, less than 2 mm, less than 3 mm, less than 4 mm, less than 5 mm, less than 6 mm, less than 7 mm, less than 8 mm, less than 9 mm, less than 10 mm, less than 15 mm, or less than 20 mm.

In other embodiments, the plant part comprises a bark. In some variations, the method comprises exerting a force on the at least one strike zone of the chassis to at least partially insert the at least one penetrating element into the plant part when the bark has a thickness of at least 0.1 inches, at least 0.2 inches, at least 0.3 inches, at least 0.5 inches, at least 1 inches, at least 1.5 inches, at least 2 inches, at least 2.5 inches, or at least 3 inches. In some embodiments, the method comprises fixing the chassis onto the plant part using one or more fastening elements when the bark has a thickness of less than 0.1 inches, less than 0.2 inches, less than 0.3 inches, less than 0.5 inches, less than 1 inches, less than 1.5 inches, less than 2 inches, less than 2.5 inches, or less than 3 inches.

In some embodiments, the fluid delivery device comprises a nozzle and contains a liquid formulation, and the method comprises connecting the adapter inserted in the top opening of the top element of the chassis with the nozzle of the fluid delivery device.

In some aspect, provided herein are methods of using the chassis, devices, kits, and systems provided herein. In some embodiments, the method comprises inserting an injection tool into the plant part. In some variations, the injection tool is connected to one end of a tubing, and the other end of the tubing is connected to the adapter. In some variations, the method comprises inserting the adapter in the top opening of the top element of the chassis, thereby forming a light fit between the adapter and the top element of the chassis. In some variations, the method comprises inserting the at least one penetrating element into the plant part. In some variations, the method comprises inserting the fluid delivery device between the adapter and the base element of the chassis.

In some embodiments, inserting the at least one penetrating element into the plant part comprises striking the at least one strike zone of the chassis with a hammer. In some variations, inserting the fluid delivery device between the adapter and the base element of the chassis comprises connecting the adapter with the nozzle of the fluid delivery device. In some variations, the plant part comprises bark. In some variations, the bark has a thickness of at least 1 mm, at least 2 mm, at least 3 mm, at least 4 mm, at least 5 mm, at least 6 mm, at least 7 mm, at least 8 mm, at least 9 mm, at least 10 mm, at least 15 mm, or at least 20 mm. In other variations, the bark has a thickness of at least 0.1 inches, at least 0.2 inches, at least 0.3 inches, at least 0.5 inches, at least 1 inches, at least 1.5 inches, at least 2 inches, at least 2.5 inches, or at least 3 inches.

In another aspect, provided herein are methods of using the chassis, devices, kits, and systems provided herein. In some embodiments, the method comprises inserting an injection tool into the plant part, wherein the injection tool is connected to one end of a tubing, wherein the other end of the tubing is connected to the adapter. In some variations, the method comprises inserting the adapter in the top opening of the top element of the chassis, thereby forming a light fit between the adapter and the top element of the chassis. In some variations, the method comprises fixing the chassis onto the plant part using the one or more fastening elements. In some variations, the method comprises inserting the fluid delivery device between the adapter and the base element of the chassis.

In some embodiments, fixing the chassis onto the plant part using the one or more fastening elements comprises passing a wire through the one or more side openings and around the plant part. In some variations, inserting the fluid delivery device between the adapter and the base element of the chassis comprises connecting the adapter with the nozzle of the fluid delivery device. In some variations, the plant part comprises bark. In some variations, the bark has a thickness of less than 1 mm, less than 2 mm, less than 3 mm, less than 4 mm, less than 5 mm, less than 6 mm, less than 7 mm, less than 8 mm, less than 9 mm, less than 10 mm, less than 15 mm, or less than 20 mm.

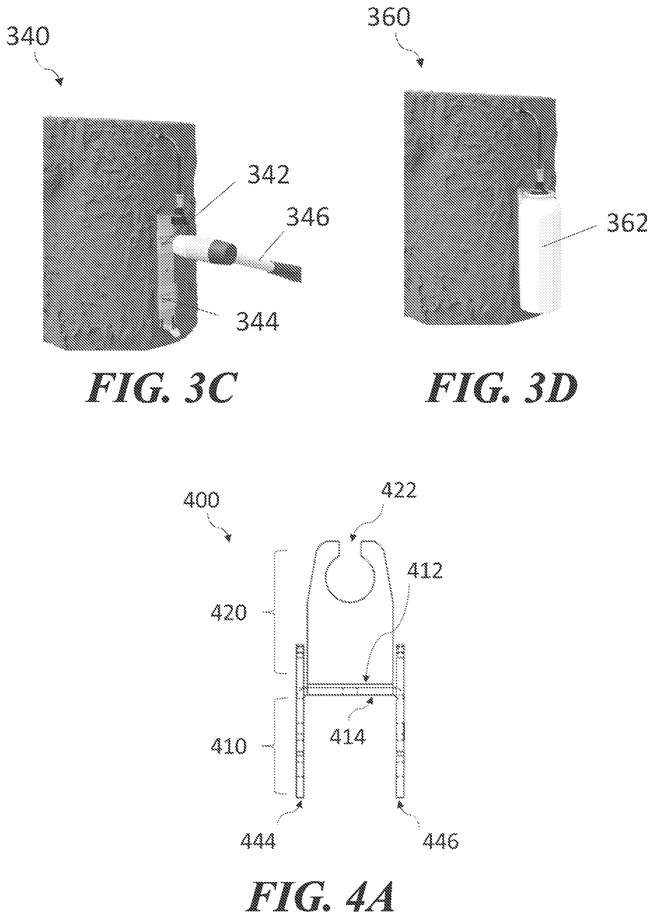

With reference to FIGS. 3A-3D, steps 300, 320, 340, and 360 of using chassis 322 are depicted. FIG. 3A depicts step 300, where injection tool 302 connected to tubing 304 and adapter 306 is inserted into tree trunk 308. FIG. 3B depicts step 320, where chassis 322 comprises main frame 324, top element 326, and base element 328. In step 320, adapter 306 is inserted into top opening 330 of top element 326. FIG. 3C depicts step 340, where hammer 346 is used to exert force onto strike zones 342 and/or 344 of chassis 322 to insert penetrating elements of chassis 322 into tree trunk 308. FIG. 3D depicts step 360, where pressurized canister 362 is inserted between adapter 306 and base element 328 of chassis 322, to release liquid formulation inside pressurized canister 362 into tree trunk 308 through tubing 304 and injection tool 302.

### Injection Systems

Chassis and methods of using the chassis described herein can be used as part of any injection systems compatible with the chassis. In some embodiments, the injection system comprises the chassis described herein. In some embodiments, the injection system comprises a liquid delivery device, e.g., a pressurized canister. In some embodiments, the injection system comprises a liquid delivery device connected to an injection tool.

In some embodiments, the plant injection system comprises a fluid delivery device comprising a nozzle and containing a liquid formulation. In some variations, the system comprises a chassis described herein, configured to position and mount the fluid delivery device onto a plant part. In some variations, the system comprises an injection tool, operatively connected to the fluid delivery device and configured to receive the liquid formulation from the fluid delivery device and to release the liquid formulation into the plant part. In some embodiments, the fluid delivery device is a pressurized canister. In some variations, the plant the liquid formulation comprises one or more active ingredients. In some variations, the injection tool releases the liquid formulation into the active vasculature of the plant part.

In some embodiments, the plant injection system further comprises an adapter for interfacing with the nozzle of the fluid delivery device. In some variations, the system further comprises a tubing configured to connect to the injection tool on one end and to the adapter on the other end.

### Liquid Delivery Device

In some embodiments, the fluid delivery device is a single unit formulation cartridge that stores, pressurizes, and delivers a liquid formulation. In some variations, the fluid delivery device is a canister containing a liquid formulation and a piston that pressurizes the liquid. In some variations, the piston is loaded by a spring that is held in a compressed position by a plunger. When, for example, a pin is removed to release the plunger, the piston pressurizes the fluid and when the canister is in the open position providing fluid communication between the canister and injection tool, fluid flows from the canister to the injection tool.

In some embodiments, the fluid delivery device comprises a formulation cartridge which delivers formulation into a plant without active operation by the installer or technician (e.g., operating a plunger, syringe, injection device, or the like). Instead, the plant injection systems comprising the formulation cartridge provide a quantity of liquid formulation and a mechanism for delivering the quantity of formulation to an injection tool for distribution to a plant. In some embodiments, the injection tool has a distribution shaft and a tool adapter configured to couple with a complementary cartridge adapter of the formulation cartridge. The distribution shaft of the injection tool has one or more distribution ports and a delivery channel (including one or more component channels) extending between the tool adapter and the one or more distribution ports. The tool adapter is accessible from the plant exterior while the one or more distribution ports and the associated portion of the distribution shaft are installed within the plant.

In some embodiments, the formulation cartridge includes a formulation reservoir including a quantity of a liquid formulation comprising one or more active ingredients. In some variations, the formulation cartridge includes a cartridge adapter complementary to the tool adapter of the injection tool. In some variations, a seal port is proximate to the cartridge adapter, and coupling of the formulation cartridge with the injection tool (e.g., including direct or indirect coupling) opens the formulation reservoir through the seal port. The liquid formulation is communicated through the seal port and the cartridge adapter through the delivery channel of the injection tool to the one or more distribution ports for delivery to plant. In one example, the seal port automatically reseals when not coupled with the injection tool to minimize leaking or distribution of the liquid formulation to the environment exterior to the cartridge when not coupled with the tool. Accordingly, liquid formulations that are rated, certified or labelled for internal (as opposed to external, sprayed or topical formulations) are readily administered with the plant injection system including the formulation cartridges and injection tools described herein while leaking and corresponding external distribution are minimized (e.g., reduced or eliminated).

In some embodiments, the formulation cartridge stores the liquid formulation and drives the formulation into the injection tool when coupled with the injection tool. For instance, a bias membrane is provided with the formulation cartridge that applies a delivery pressure to the liquid formulation for delivery to the injection tool. The delivery pressure is optionally generated through one or more mechanisms including, but not limited to, elastic deformation of an elastic bias membrane, a pressurized driving fluid in an opposed cavity to the formulation reservoir, combinations of the same or the like. In some variations, the bias membrane thereby drives the liquid formulation to the injection tool upon coupling and with minimal interaction (e.g., reduced or none) from the installer or technician. In one example, the formulation cartridge provides the liquid formulation and the delivery mechanism for the liquid formulation in a consolidated package that is readily coupled with the installed injection tool. Further, formulation cartridges are readily coupled, decoupled and replaced with fresh cartridges through the complementary cartridge and tool adapters to ensure liquid formulations are delivered from the formulation cartridges to the plant interior (e.g., vasculature) with minimized leaking or external distribution.

In the context of coupling between the formulation cartridge and the injection tool, the interconnection between the cartridge and the injection tool includes direct and indirect coupling. Accordingly, the formulation cartridge may still be used as the fluid delivery device even if the injection tool does not include a tool adaptor and/or the formulation cartridge is not fitted with a complimentary cartridge adaptor. For instance, the adapters described herein are optionally provided with the respective formulation cartridge or injection tool in one example. In another example, the adapters (which may simply be ports) are provided with one or more intermediate components to facilitate indirect coupling between the formulation cartridge and the injection tool (e.g., with intervening tubing, manifolds or the like). In some variations, the connection between the cartridge and tool adapters includes various mechanisms. For example, the adapter arrangements include, but are not limited to, clips, clamps, complementary threading, interference fittings, bayonet fittings, detents or the like. Optionally, the adaptors are configured to interfit with a robust coupling (e.g., with a detent, bayonet fitting or the like) to minimize incidental decoupling between the cartridge and the injection tool.

In some variations, the fluid delivery device comprises a spring-loaded fluid delivery device. In certain variations of the foregoing, the spring-loaded fluid delivery device is configured to operate at a pressure between 1.5-3 bar. In other variations, the fluid delivery device comprises a pressurized container (e.g., a pressurized canister).

In some embodiments, the formulation cartridge has a cartridge adaptor that is complementary to a tool adaptor on the injection tool for integrating the components into a plant injection system with fluid communication between them. However, the formulation cartridge does not require a specialized complementary adaptor and can be fitted for use with other injector tools for example using ports for fluid access, and tubing and valves to create selective fluid communication as desired.

In some embodiments, the injection tool has a distribution shaft (e.g., an insert portion) and a first adapter arrangement. In some variations, the distribution shaft of the injection tool has one or more distribution ports and an interior duct extending between the first adapter arrangement and the discharge opening. In some variations, the interior duct can be any internal cavity suitable to connect the discharge opening with the first adapter arrangement. For example, it can comprise a channel system having a single or plural channels for connecting the first adapter arrangement with the at least one discharge opening.

In some embodiments, the injection tool is further arranged such that the first adapter arrangement is accessible from outside the plant while the distribution shaft and the distribution ports are inside the plant when the insert portion is inserted into the plant.

In some embodiments, the formulation cartridge includes a chamber optionally comprising a dose of the liquid formulation, and a second adapter arrangement corresponding to the first adapter arrangement of the injection tool. In some variations, the first adapter arrangement of the injection tool and the second adapter arrangement of the formulation cartridge are configured for coupling such that the interior duct of the injection tool and the chamber of the formulation cartridge are in fluid communication.

The term “in fluid connection” relates to a direct or indirect connection enabling a transfer of fluid, particularly from the formulation cartridge to the injection tool. For this, the formulation cartridge and the injection tool can either be directly or indirectly arranged at or mounted to each other. The connection between the formulation cartridge and the injection tool is, in one example, sealed or leak tight and formulation leaks are minimized (e.g., reduced or eliminated) with the coupled components when transferred from the formulation cartridge to the injection tool.

In some embodiments, for connecting the first and second adapter arrangements to each other various mechanisms are considered. For example, the adapter arrangements are configured for coupling by way of clipping, clamping, screwing, sticking or the like. In one example, the adapter arrangements include a bayonet structure for coupling and decoupling from each other. In another example, the formulation cartridge is clipped or button with the injection tool (e.g., in the manner of a push button, deflectable coat button or the like).

Plants are exposed to many microbes, including bacteria, viruses, fungi, and nematodes. Diseases of ornamental plants, forests, and other plants caused by such plant pathogens, particularly bacterial pathogens, are a worldwide problem with enormous economic impact. The severity of the destructive process of disease depends on the aggressiveness of the phytopathogen and the response of the host.

In some embodiments, the plant injection system comprising formulation cartridges according to the disclosure allows for the efficient and sealed introduction of liquid formulations into plants. In one example, the injection tool is installed in the plant in a first step and the formulation cartridge is coupled with the injection tool and thereafter administers the liquid formulation to the injection tool for delivery to the plant interior. The adapter arrangements described herein minimize leakage or escape of the liquid formulation from the closed plant injection system of the formulation cartridge and the injection tool. In situations with liquid formulations indicated for internal use only, are toxic for animals, or affect the environment in an undesired manner the adapter arrangements enclose the delivery of the liquid formulation from the cartridge to the tool for distribution in the interior of the plant. Additionally, example plant injection system comprising the formulation cartridge allows for safe and convenient storage and delivery of one or more doses or boluses of the an liquid formulation or combinations of different liquid formulations (e.g., with the replacement of formulation cartridges having varied formulations). Further, example plant injection systems comprising the formulation cartridge allow for a convenient long-term treatment of the plant by a comparably low skilled user. As such, an efficient and accurate delivery of the liquid formulation into the plant may be achieved.

In some embodiments, the injection tool can be set or advanced into the plant independent of the formulation cartridge and thus the liquid formulation. This allows for providing a safe process not risking any leakage or other disposal of the liquid formulation out of the system. Further, the plant injection system allows for a convenient long-term treatment of the plant by a comparably low skilled user, which may result in an efficient and accurate delivery of the liquid formulation into the plant.

With regard to the injection tool, any injection tool consistent with this disclosure may be used with the formulation cartridge. In some embodiments, for example, when the injection tool is inserted for long-term use, the injection tool is configured to be secured into the plant such that the insert portion is not readily linearly extractable out of the plant.

With regard to the formulation cartridge, the liquid formulation is optionally pressurized, in one example, in a formulation reservoir of the cartridge. Pressurizing the formulation allows for convenient delivery of the formulation from the cartridge and to the tool installed in the plant once the formulation reservoir is opened via coupling of the adapter arrangements. In one example, the liquid formulation is immediately delivered upon opening of the formulation reservoir, for instance through coupling of the tool and cartridge adapters. In some variations, the formulation immediately flows into the tool according to the maintained driving pressure or force. Optionally, the driving pressure or force is maintained (including gradual abatement) during operation of the plant injection system as the driving mechanism (e.g., a bias membrane or the like) is gradually operated as the formulation is taken up by the plant.

In one example, the cartridge is configured with a bias membrane, for example an elastic bias membrane, which defines an upper boundary of the formulation reservoir within the cartridge. The bias membrane (e.g., elastic, pliable, compliant or semi-compliant) deflects and by virtue of stretching or a pressurized driving fluid pressurizes the liquid formulation. Such membrane can form the boundary of the chamber or at least a portion thereof. It can also be arranged inside the chamber as additional element. By selecting an appropriate material having a suitable elasticity, and/or optionally providing a quantity of compressed air or gas to the evacuated side of the chamber (on the opposite side of the membrane as the formulation reservoir) to further deflect the membrane, pressure is applied to the liquid formulation.

In another example, the adapter arrangement of the formulation cartridge comprises a self-sealing port and the complementary adapter arrangement of the injection tool has a piercing member configured to open the self-sealing port, for instance through penetration of the self-sealing port when the cartridge adaptor and injector adaptor are coupled, resulting in fluid communication between the fluid reservoir and injector tool. In some variations, the self-sealing port closes with removal of the injector adaptor, which may minimize leaking of the liquid formulation.

In some embodiments, the seal port is optionally configured in one or more suitable manners to facilitate reversible opening of the port on introduction and then removal of a piercing member. In one example, the self-sealing port includes a septum that is piercable by the piercing member. The self-sealing port may be equipped with a duckbill valve. A duckbill valve may facilitate efficiently and tightly accessing the interior of the formulation reservoir by means of the piercing member, may provide leak tightness after removing the piercing member, and may be multiply accessed without losing its leak tightness. The complementary piercing member may be a spike, fitting, nipple, needle or the like, configured to pierce the duckbill valve, and for accessing the dose of liquid formulation in the formulation reservoir.

In another example, the formulation cartridge includes an input port configured to fill the formulation reservoir with a quantity such as a dose of the liquid formulation. The input port facilitates enables re-filling the formulation reservoir and consequently reuse of the formulation cartridge. Accordingly, in some embodiment, a formula cartridge is a multiple-use cartridge. In other embodiments, the formulation cartridge is a one-use product that is disposed after use.

In another example, the formulation cartridge has a reservoir casing enclosing the formulation reservoir. The reservoir casing is constructed with robust materials, in one example to protect the interior including, for instance, the bias membrane, liquid formulation (to prevent leaking) or the like. In another example, the reservoir casing is filled with a pressurized medium, such as a gas, in an opposed portion of the casing relative to the formulation reservoir. For instance, the pressurized medium is provided on the opposed side of the bias membrane to apply pressure through the bias membrane to the formulation in the formulation reservoir. Alternatively, the pressurized medium cooperates with an elastic (elastically deformable) bias membrane to provide additional pressure to the formulation for delivery.

In some embodiments, the formulation cartridge can deliver similar active ingredients as other fluid delivery devices used in plant injection systems in accordance with this disclosure including an insecticide, a fungicide, a nutrient, a growth promoter or a combination thereof.

### Liquid Formulations

Any suitable liquid formulations may be used in the injection systems compatible with the chassis and the liquid delivery devices described herein. In some embodiments, the liquid formulation is water soluble. In some variations, the liquid formulation comprises nutrients. In some variations, the liquid formulation comprises micronutrients. In some variations, the liquid formulation is a semi-liquid formulation. In some variations, the liquid formulation is a gel formulation. In some variations, the liquid formulation is delivered as a semi-liquid or a gel formulation.

In some embodiments, the liquid formulation comprises one or more active ingredients. In some variations, formulations are prepared, e.g., by mixing the active ingredients with one or more suitable additives such as suitable extenders, solvents, spontaneity promoters, carriers, emulsifiers, dispersants, frost protectants, biocides, thickeners, adjuvants or the like. An adjuvant in this context is a component which enhances the biological effect of the formulation, without the component itself having a biological effect. Examples of adjuvants are agents which promote the retention, spreading, or penetration in the target plant. One embodiment of the disclosure comprises a long-term supply of the active ingredient to the plant over the growing season, with an auxiliary being stabilizers, such as low-temperature stabilizers, preservatives, antioxidants, light stabilizers or other agents which improve chemical and/or physical stability.

Examples of typical liquid formulations include water-soluble liquids (SL), emulsifiable concentrates (EC), emulsions in water (EW), suspension concentrates (SC, SE, FS, OD), water-dispersible granules (WG) and fluids (which include one or more of a liquid, gas, gel, vapor, aerosol or the like). These and other possible types of formulation are described, for example, by Crop Life International and in Pesticide Specifications, Manual on development and use of FAO and WHO specifications for pesticides, FAO Plant Production and Protection Papers, prepared by the FAO/WHO Joint Meeting on Pesticide Specifications, 2004, ISBN: 9251048576; “Catalogue of pesticide formulation types and international coding system,” Technical Monograph No. 2, 6th Ed. May 2008, CropLife International.

In some embodiments, compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. Formulations are prepared, e.g., by mixing the active ingredients with one or more suitable additives such as suitable extenders, solvents, spontaneity promoters, carriers, emulsifiers, dispersants, frost protectants, biocides, thickeners, adjuvants or the like. An adjuvant in this context is a component which enhances the biological effect of the formulation, without the component itself having a biological effect. Examples of adjuvants are agents which promote the retention, spreading, or penetration in the target plant. One embodiment of the disclosure comprises a long-term supply of the active ingredient to the plant over the growing season, with an auxiliary being stabilizers, such as low-temperature stabilizers, preservatives, antioxidants, light stabilizers or other agents which improve chemical and/or physical stability.

Examples for suitable auxiliaries are solvents, liquid carriers, surfactants, dispersants, emulsifiers, wetters, adjuvants, solubilizers, penetration enhancers, protective colloids, humectants, repellents, attractants, feeding stimulants, compatibilizers, bactericides, anti-freezing agents, antifoaming agents, colorants, stabilizers or nutrients, UV protectants, tackifiers, and/or binders. Specific examples for each of these auxiliaries are well known to the person of ordinary skill in the art, see, for example, US 2015/0296801 A1.

The compositions can optionally comprise 0.1-80% stabilizers and/or nutrients and 0.1-10% UV protectants. General examples of suitable ratios for multiple formulation types referenced above are given in Agrow Reports DS243, T&F Informa, London, 2005.

At certain application rates, the compositions and/or formulations according to the disclosure may also have a strengthening effect in plants. “Plant-strengthening” (resistance-inducing) substances are to be understood as meaning, in the present context, those substances or combinations of substances which are capable of stimulating the defence system of plants in such a way that, when subsequently inoculated with harmful microorganisms, the treated plants display a substantial degree of resistance to these microorganisms.

### Active Ingredients

In some embodiments, when applying active ingredients, the application can be continuous over a longer period or intervals. In some variations, the application could also be coupled with a disease monitoring system and be triggered “on demand.” In some variations, the formulations can comprise between 0.5% and 90% by weight of active compound, based on the weight of the formulation.

Numerous active ingredients can be used in the injection systems compatible with the tip adapters and tip setters described herein. The active ingredients specified herein by their “common name” are known and described, for example, in The Pesticide Manual (18th edition, Ed. Dr. J A Turner (2018), which includes, among other agents, herbicides, fungicides, insecticides, acaricides, nematocides, plant growth regulators, repellents, synergists) or can be searched in the internet (e.g., alanwood.net/pesticides).

### Injection Tools

Any injection tools compatible with the chassis and the liquid delivery devices described herein may be used. Suitable injection tools are described in, e.g., WO 2020/021041. For example, in some embodiments, the injection tools include a tool body, at least a portion of which is designed to be lodged into a plant, for example, the stem or trunk of a plant. The tool body has a channel system (having one or more channels) through which fluid can flow, terminating in an entry port through which fluid enters the injection tool and one or more distribution ports through which fluid is delivered to the interior of the plant. In some embodiments, the channel system provides fluid communication between the distribution ports and access ports. A person of skill, based upon this disclosure can envision a variety of injection tools that may be modified as multiport injection tools consistent with this disclosure. For example, in some variations, other injection tools described herein can be modified to include two access ports in fluid communication with a channel system providing fluid communication between the access ports and distribution ports.

In some embodiments, the multiport injection tool compatible with the tip adapters and tip setters described herein has an insertion end which is inserted into a plant and an exposed end which remains outside of the plant to facilitate coupling and decoupling of the multiport injection tool to the fluid delivery system and/or the fluid receiving system. In some embodiments, multiport injection tip is sized and shaped to minimize damage to the target plant when inserted into the plant, while maintaining efficient functionality of the tip in delivering the desired dosing of active ingredients in liquid formulations over the desired time period directly to the sapwood and not the heartwood of the trunk.

In some embodiments, the injection tool is a multiport injection tool including a first access port, a second access port, the one or more distribution ports, and the channel system, which establishes fluid communication between the first and second access ports and the one or more distribution ports. In some variations, when the multiport injection tool is used in a plant injection system having a fluid receiving device, the multiport injection tool is positioned in the trunk of a plant in fluid communication with the fluid delivery system, and the fluid delivery system is activated, fluid flows from the fluid delivery device through the multiport injection tool from the first access port to the distribution ports for delivery into the trunk of a plant and to the second access port.

Without being bound by theory, it is believed that because the one or more distribution ports administer liquid formulations along a different vector relative to the longitudinal body axis of the penetrating distribution body, the ports remain open (e.g., clear of plant tissue) and minimal pressure (relative to pressure applied with a driven plunger and cylinder) administers the liquid formulation. For example, the one or more distribution ports open, extend laterally, distribute the liquid formulation or the like in a misaligned orientation (e.g., transverse, along an offset angle, orthogonal, greater than 5 degrees, greater than 10 degrees or more) relative to the longitudinal body axis to thereby minimize clogging from plant tissue.

In other examples, the one or more distribution ports are recessed from an exterior of a body profile of the penetrating distribution body, and accordingly remain clear of plant tissue. For example, the one or more distribution ports are provided along the troughs of anchor elements (e.g., threading, flutes, serrations, cleats, scalloped surfaces or the like), within distribution reservoirs within the body profile of the penetrating distribution body or the like. In some embodiments, the one or more distribution ports are within the body profile and with penetration of the plant tissue the ports are not engaged with plant tissue in a manner that promotes clogging. Instead, the one or more distribution ports are recessed from the penetrating element and, at least in some examples, the plant tissue itself. Accordingly, liquid formulations delivered to the injection tool are readily received in the plant and delivered with minimal pressure or effort. Further, in examples including cavities, the proximate walls, surfaces or the like of the injection tool in combination with the surrounding plant tissue provide reservoirs within the plant, and the liquid formulations reside in these reservoirs for gradual uptake by the plant.

In some embodiments, the injection tools described herein are installed in plants having relatively small and large sizes or diameters (e.g., trunk or stem diameters). In one example, the portions of the injection tools installed in plants have dimensions of around 5 mm or less (e.g., width) and 1 mm or less (e.g., height) and accordingly the tools are configured for installation in plants with stems, trunks, roots, limbs or the like of 5 mm or more in size, such as diameter.

In some variations, any injection tool compatible with the tip adapters and tip setters described herein may be used further with a formulation cartridge. In some embodiments, the injection tool can be set or advanced into the plant independent of the formulation cartridge and thus the liquid formulation. This allows for providing a safe process not risking any leakage or other disposal of the liquid formulation out of the system. Further, the plant injection system allows for a convenient long term treatment of the plant by a comparably low skilled user, which may result in an efficient and accurate delivery of the liquid formulation into the plant.

In some embodiments, for example, when the injection tool is inserted for long-term use, the injection tool is configured to be secured into the plant such that the insert portion is not readily linearly extractable out of the plant.

In some embodiments, the lodged portion of the tool is sized and shaped to minimize damage to the target plant when inserted into the plant, while maintaining efficient functionality of the injection tool in delivering the desired dosing of liquid formulation over the desired time period directly to the active vasculature of the plant. In some variations, penetrating element and tool base are cooperatively sized and shaped to work together to minimize damage to the target plant while maintaining efficient functionality of the tip. For example, the length of penetrating element may be chosen to be less than the depth of the sapwood in the trunk of the tree and tool base is configured with a flange abutting the bottom end of penetrating element. In some variations, the flange is sized and shaped to mitigate the risk of inserting the injection tool beyond the end of penetrating element abutting flange and therefore beyond the inner circumference of the sapwood and into the heartwood. In some variations, flange has a width that is wider than the widest part of penetrating element. In one example, the multiport injection tip includes one or more dimensions configured to minimize trauma to the plant caused during installation. The minimal profile of the tip (as well as other tip embodiments described herein) minimizes trauma to a plant in comparison to larger profile devices including syringes, plug, pegs or the like having dimensions of around 7 mm (7.14 mm in one example) a full 2 mm larger than the example tip. Accordingly, the potential for tree damage is reduced and the potential for fungal, bacterial, and insect ingress is minimized (e.g., reduced or eliminated). In one example, the tip as well as the other tip examples described herein are readily used with plants having stems, trunks, limbs or the like having diameters larger than 4.68 mm including, but not limited to, fruit trees, nut trees, berry shrubs, flowering plants as well as arbor and forest trees.

In certain embodiments, the injection tools selected allow for precision delivery (also referred to as “precision injection”) of a formulation into the plant. Precision delivery refers to delivering the formulation only or substantially only into a target location in the plant. For example, in some embodiments, the target location is the active vasculature of the tree. In some variations, the active vasculature of a tree is the xylem and/or the phloem. In other embodiments, precisely delivering the liquid formulation comprises inserting the injection tool such that the distribution reservoir is positioned in and no further than the active vasculature of the plant.

### Tip Setters and Tip Adapters

Any suitable tip setters and/or tip adapters can be used to install the injection tool into the plant part. These tip setters and tip adapters enable safe, efficient, and controlled installation of injection tools to plant parts. In some embodiments, the tip setter is a rod-type tip setter, a plunger-type tip setter, a lever-type tip setter, or automatic hammer tip setter.

### Kits

In some aspects, provided herein are kits. In some embodiments, a kit comprises a chassis and a liquid delivery device provided herein. In some variations, a kit comprises a chassis, a liquid delivery device, and a package insert containing instructions for use (e.g., for installing or using the chassis and the liquid delivery device). In some variations, the liquid delivery device contains a liquid formulation comprising one or more active ingredients. In some variations, the liquid delivery device can be refilled with a liquid formulation.

In some embodiments, the kit further comprises an injection tool. In some variations, a kit comprises a chassis, a liquid delivery device, and an injection tool provided herein. In some variations, a kit comprises a chassis, a liquid delivery device, an injection tool, and a package insert containing instructions for use (e.g., for installing or using the chassis with the liquid delivery device and the injection tool). In some variations, the liquid delivery device contains a liquid formulation comprising one or more active ingredients. In some variations, the liquid delivery device can be refilled with a liquid formulation.

In some embodiments, the kit further comprises an adapter. In some variations, the kit further comprises a tubing. In some variations, a kit comprises a chassis, a liquid delivery device, an injection tool, an adapter, and a tubing provided herein. In some variations, a kit comprises a chassis, a liquid delivery device, an injection tool, an adapter, a tubing, and a package insert containing instructions for use (e.g., for installing or using the chassis with the liquid delivery device, the injection tool, the adapter, and the tubing). In some variations, the liquid delivery device contains a liquid formulation comprising one or more active ingredients. In some variations, the liquid delivery device can be refilled with a liquid formulation.

In some embodiments, the kit further comprises a fastening element. In some variations, a kit comprises a chassis and a fastening element. In some variations, a kit comprises a chassis, a fastening element, and a package insert containing instruction for use (e.g., how and when to use the fastening element with the chassis).

### Enumerated Embodiments

The following enumerated embodiments are representative of some aspects of the invention.

1. A chassis configured to position and mount a fluid delivery device onto a plant part, wherein the fluid delivery device comprises a nozzle and contains a liquid formulation,
wherein the chassis comprises: a main frame, a top element, and a base element, wherein the main frame is connected on one end to the top element and connected on the other end to the base element,
   wherein the main frame has a bottom surface and a top surface, and comprises at least one penetrating element configured to at least partially penetrate into the plant part,
      wherein the top surface of the main frame comprises at least one strike zone configured to receive a force exerted along a penetrating direction sufficient to cause the at least one penetrating element to at least partially penetrate into the plant part along the penetration direction, and wherein the top surface is further configured to receive the fluid delivery device,
   wherein the top element comprises a top opening configured to receive an adapter for interfacing with the nozzle of the fluid delivery device; and
   wherein the base element is configured to come into contact with the bottom of the fluid delivery device.
      2. The chassis of embodiment 1, wherein, when the fluid delivery device is positioned between the top element and the base element of the chassis, the top element and the base element exert opposite forces to hold the fluid delivery device in position within the chassis, and
the nozzle of the fluid delivery device is in contact with the adapter held in position by the top element, wherein the chassis exerts a pressure on the nozzle to release the liquid formulation through the nozzle.
   3. The chassis of embodiment 1 or 2, wherein the chassis is made from a material that has one or more of the following properties:
(i) flexibility to allow insertion of the adapter and the liquid delivery device between the top element and the base element;
(ii) rigidity to hold the liquid delivery device in between the top element and the base element and to trigger release of the liquid formulation from the liquid delivery device;
(iii) resistance to moisture such that the chassis experiences little to no deformation upon prolonged exposure to moisture;
(iv) resistance to corrosion such that the chassis experiences little to no rust over time and usage;
(v) inertness such that the chassis does not release any metal ions, or any substantial amount of metal ions, into the environment; or
(vi) formability such that the chassis, if damaged and/or deformed, can easily be repaired by bending the chassis back to its original position;
or any combination of the foregoing.
   4. The chassis of embodiment 3, wherein the material comprises metal.
   5. The chassis of embodiment 3 or 4, wherein the material comprises stainless steel.
   6. The chassis of any one of embodiments 1 to 5, wherein the chassis is in loaded state when the adapter is inserted in the top opening and the liquid delivery device is inserted between the adapter and the base element, and the chassis is in unloaded state when the liquid delivery device is not inserted between the adapter and the base element, wherein the displacement of the top element and the displacement of the base element between the loaded state and the unloaded state are small enough to trigger release of the liquid formulation from the liquid delivery device.
   7. The chassis of embodiment 6, wherein the sum of the displacement of the top element and the displacement of the base element between the loaded state and the unloaded state is less than 0.05 mm.
   8. The chassis of any one of embodiments 1 to 7, wherein the main frame comprises four penetrating elements, wherein first and second penetrating elements are positioned near the top element, and third and fourth penetrating elements are positioned near the base element.
   9. The chassis of any one of embodiments 1 to 8, wherein the top surface of the main frame comprises two strike zones, wherein first strike zone is positioned near the top element, and second strike zone is position near the base element.
   10. The chassis of any one of embodiments 1 to 9, wherein the adapter is connected to an injection tool through a tubing.
   11. The chassis of any one of embodiments 1 to 10, wherein the penetrating direction is substantially perpendicular to the bottom surface and the top surface of the main frame.
   12. The chassis of any one of embodiments 1 to 11, wherein the main frame further comprises one or more side openings, wherein the one or more side openings are configured to receive one or more fastening elements such that the chassis can be fixed onto the plant part with the one or more fastening elements.
   13. The chassis of embodiment 12, wherein the one or more fastening elements are wire, rope, thread, cloth, band, belt, or fiber, or any combination thereof.
   14. A plant injection system, comprising:
a fluid delivery device comprising a nozzle and containing a liquid formulation;
a chassis of any one of embodiments 1 to 13, configured to position and mount the fluid delivery device onto a plant part; and an injection tool, operatively connected to the fluid delivery device and configured to receive the liquid formulation from the fluid delivery device and to release the liquid formulation into the plant part.
   15. The plant injection system of embodiment 14, wherein the fluid delivery device is a pressurized canister.
   16. The plant injection system of embodiment 15, wherein the liquid formulation comprises one or more active ingredients.
   17. The plant injection system of any one of embodiments 13 to 16, wherein the injection tool releases the liquid formulation into the active vasculature of the plant part.
   18. The plant injection system of any one of embodiments 14 to 17, wherein the system further comprises an adapter for interfacing with the nozzle of the fluid delivery device.
   19. The plant injection system of embodiment 18, wherein the system further comprises a tubing configured to connect to the injection tool on one end and to the adapter on the other end.
   20. A method for positioning and mounting a chassis of any one of embodiments 1 to 13 onto a plant part, the method comprising:
positioning the chassis against the plant part; and
exerting a force on the at least one strike zone of the chassis to at least partially insert the at least one penetrating element into the plant part.
   21. A method for positioning and mounting a chassis of embodiment 12 or 13 onto a plant part, the method comprising:
positioning the chassis against the plant part; and
fixing the chassis onto the plant part using one or more fastening elements.
   22. The method of embodiment 20 or 21, further comprising mounting a fluid delivery device onto the chassis.
   23. The method of any one of embodiments 20 to 22, wherein the fluid delivery device comprises a nozzle and contains a liquid formulation, and wherein the method further comprises connecting the adapter inserted in the top opening of the top element of the chassis with the nozzle of the fluid delivery device.
   24. A method of using the chassis of any one of embodiments 1 to 13, comprising:
inserting an injection tool into the plant part, wherein the injection tool is connected to one end of a tubing, wherein the other end of the tubing is connected to the adapter;
inserting the adapter in the top opening of the top element of the chassis, thereby forming a light fit between the adapter and the top element of the chassis;
inserting the at least one penetrating element into the plant part; and
inserting the fluid delivery device between the adapter and the base element of the chassis.
   25. The method of embodiment 24, wherein inserting the at least one penetrating element into the plant part comprises striking the at least one strike zone of the chassis with a hammer.
   26. The method of embodiment 24 or 25, wherein inserting the fluid delivery device between the adapter and the base element of the chassis comprises connecting the adapter with the nozzle of the fluid delivery device.
   27 The method of any one of embodiments 24 to 26, wherein the plant part comprises bark.
   28. The method of embodiment 27, wherein the bark has a thickness of at least 3 mm.
   29. A method of using the chassis of embodiment 12 or 13, comprising:
inserting an injection tool into the plant part, wherein the injection tool is connected to one end of a tubing, wherein the other end of the tubing is connected to the adapter;
inserting the adapter in the top opening of the top element of the chassis, thereby forming a light fit between the adapter and the top element of the chassis;
fixing the chassis onto the plant part using the one or more fastening elements; and
inserting the fluid delivery device between the adapter and the base element of the chassis.
   30. The method of embodiment 29, wherein fixing the chassis onto the plant part using the one or more fastening elements comprises passing a wire through the one or more side openings and around the plant part.
   31. The method of embodiment 29 or 30, wherein inserting the fluid delivery device between the adapter and the base element of the chassis comprises connecting the adapter with the nozzle of the fluid delivery device.
   32. The method of embodiment any one of embodiments 29 to 31, wherein the plant part comprises bark.
   33. The method of embodiment 32, wherein the bark has a thickness of less than 3 mm.

### EXAMPLES

The presently disclosed subject matter will be better understood by reference to the following Examples, which are provided as exemplary of the invention, and not by way of limitation.

### Example 1: Finite Element Analysis

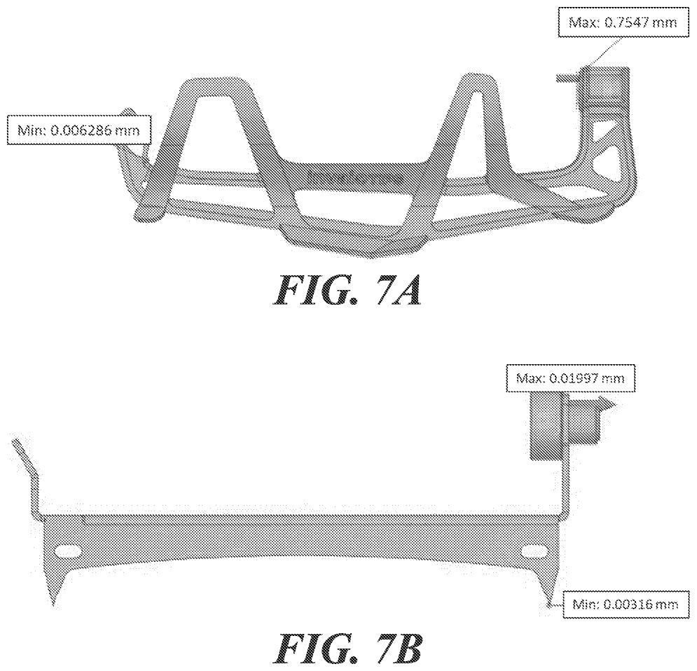

The actual deformation (displacement and stress) in a particular (poly (dodecano-12-lactam)) (Nylon 12) spray can holder depicted in FIG. 7A and a sheet metal spray can holder depicted in FIG. 7B was analyzed with a finite element analysis. Results are summarized in Table 1.

The maximum displacement was estimated with a rotational constraint at the base element of the chassis and a linear force of about 30 N at the top element of the chassis. The maximum displacement of the poly (dodecano-12-lactam) spray can holder was 0.755 mm, which may be large enough to result in insufficient triggering of the canister. The maximum displacement of the sheet metal spray can holder was about 0.02 mm, which is small enough to result in sufficient triggering of the canister. The results show that the sheet metal spray can holder covers the static requirements. For example, the minimum safety factor is about 3.9.

TABLE 1
Poly(dodecano-12-lactam) spray can holder (FIG. 7A)

| | | |
|---|---|---|
| Name | Minimum | Maximum |

Safety Factor

| | | |
|---|---|---|
| Safety Factor (Per Body) | 0.6194 | 15 |

| | | | | |
|---|---|---|---|---|
| Stress | | | | |
| Von Mises | 2.481E−05 | MPa | 32.05 | MPa |
| 1st Principal | −15.14 | MPa | 41.76 | MPa |
| 3rd Principal | −25.72 | MPa | 23.42 | MPa |
| Normal XX | −16.25 | MPa | 30.57 | MPa |
| Normal YY | −21.27 | MPa | 41.69 | MPa |
| Normal ZZ | −25.31 | MPa | 29.14 | MPa |
| Shear XY | −5.729 | MPa | 10.03 | MPa |
| Shear YZ | −12.63 | MPa | 9.355 | MPa |
| Shear ZX | −8.266 | MPa | 8.708 | MPa |
| Displacement | | | | |
| Total | 0.006286 | mm | 0.7547 | mm |
| X | −0.04642 | mm | 0.03449 | mm |
| Y | −0.1308 | mm | 0.7538 | mm |
| Z | −0.09223 | mm | 0.4075 | mm |
| Reaction Force | | | | |

| | | |
|---|---|---|
| Total | 0N | 10.41N |
| X | −2.257N | 2.441N |
| Y | −4.604N | 2.056N |
| Z | −10.4N | 3.81N |

Strain

| | | |
|---|---|---|
| Equivalent | 4.906E−08 | 0.04436 |
| 1st Principal | −8.245E−09 | 0.0399 |
| 3rd Principal | −0.03687 | −2.683E−08 |
| Normal XX | −0.01225 | 0.008593 |
| Normal YY | −0.01134 | 0.02206 |
| Normal ZZ | −0.01908 | 0.0179 |
| Shear XY | −0.01613 | 0.02825 |
| Shear YZ | −0.03555 | 0.02634 |
| Shear ZX | −0.02327 | 0.02452 |

Sheet metal spray can holder (FIG. 7B)

| Name | Minimum | | Maximum | |
|---|---|---|---|---|
| Safety Factor | | | | |
| Safety Factor (Per Body) | 3.885 | | 15 | |
| Stress | | | | |
| Von Mises | 2.336E−04 | MPa | 64.35 | MPa |
| 1st Principal | −22.18 | MPa | 60.54 | MPa |
| 3rd Principal | −63.59 | MPa | 16.25 | MPa |
| Normal XX | −24.71 | MPa | 16.45 | MPa |
| Normal YY | −49.45 | MPa | 57.27 | MPa |
| Normal ZZ | −60.71 | MPa | 43.16 | MPa |
| Shear XY | −20.11 | MPa | 21.03 | MPa |
| Shear YZ | −25.97 | MPa | 32.42 | MPa |
| Shear ZX | −19.35 | MPa | 20.23 | MPa |
| Displacement | | | | |
| Total | 0.00316 | mm | 0.01997 | mm |
| X | −4.742E−04 | mm | 0.006054 | mm |
| Y | −0.01805 | mm | 0.01997 | mm |
| Z | −0.007228 | mm | 0.01106 | mm |
| Reaction Force | | | | |
| Total | 0N | | 72.81N | |
| X | −4.397N | | 6.443N | |
| Y | −17.15N | | 14.09N | |
| Z | −72.81N | | 44.71N | |
| Strain | | | | |

| | | |
|---|---|---|
| Equivalent | 1.33E−09 | 5.254E−04 |
| 1st Principal | 1.36E−09 | 4.987E−04 |
| 3rd Principal | −5.224E−04 | 2.239E−06 |
| Normal XX | −6.414E−05 | 5.112E−05 |
| Normal YY | −2.27E−04 | 2.562E−04 |
| Normal ZZ | −2.823E−04 | 2.059E−04 |
| Shear XY | −2.709E−04 | 2.833E−04 |
| Shear YZ | −3.498E−04 | 4.368E−04 |
| Shear ZX | −2.606E−04 | 2.725E−04 |

1. A chassis configured to position and mount a fluid delivery device onto a plant part, wherein the fluid delivery device comprises a nozzle and contains a liquid formulation,
wherein the chassis comprises: a main frame, a top element, and a base element, wherein the main frame is connected on one end to the top element and connected on the other end to the base element,
wherein the main frame has a bottom surface and a top surface, wherein the top surface is configured to receive or to be in contact with the fluid delivery device,
wherein the top element comprises a top opening configured to receive an adapter for interfacing with the nozzle of the fluid delivery device; and
wherein the base element is configured to come into contact with the bottom of the fluid delivery device.

2. The chassis of claim 1, wherein the main frame comprises at least one penetrating element configured to at least partially penetrate into the plant part.

3. The chassis of claim 2, wherein the top surface of the main frame comprises at least one strike zone configured to receive a force exerted along a penetrating direction sufficient to cause the at least one penetrating element to at least partially penetrate into the plant part along the penetration direction.

4. The chassis of claim 1, wherein, when the fluid delivery device is positioned between the top element and the base element of the chassis, the top element and the base element exert opposite forces to hold the fluid delivery device in position within the chassis, and
the nozzle of the fluid delivery device is in contact with the adapter held in position by the top element, wherein the chassis exerts a pressure on the nozzle to release the liquid formulation through the nozzle.

5. The chassis of claim 1, wherein the chassis is made from a material that has one or more of the following properties:
(i) flexibility to allow insertion of the adapter and the liquid delivery device between the top element and the base element;
(ii) rigidity to hold the liquid delivery device in between the top element and the base element and to trigger release of the liquid formulation from the liquid delivery device;
(iii) resistance to moisture such that the chassis experiences little to no deformation upon prolonged exposure to moisture;
(iv) resistance to corrosion such that the chassis experiences little to no rust over time and usage;
(v) inertness such that the chassis does not release any metal ions, or any substantial amount of metal ions, into the environment; or
(vi) formability such that the chassis, if damaged and/or deformed, can easily be repaired by bending the chassis back to its original position;
or any combination of the foregoing.

6. The chassis of claim 5, wherein the material comprises metal, plastic, or a combination thereof.

7. The chassis of claim 5, wherein the material comprises stainless steel.

8. The chassis of claim 5, wherein the material comprises reinforced plastic.

9. The chassis of claim 1, wherein the minimum safety factor of the chassis is at least 1.

10. The chassis of claim 1, wherein the minimum safety factor of the chassis is between about 1 and about 5.

11. The chassis of claim 1, wherein the maximum displacement of the chassis with a rotational constraint at the base element and a linear force of about 30 N at the top element is less than about 0.5 mm.

12. The chassis of claim 1, wherein the maximum displacement of the chassis with a rotational constraint at the base element and a linear force of about 30 N at the top element is between about 0.01 mm and about 0.025 mm.

13. The chassis of claim 1, wherein the chassis is in loaded state when the adapter is inserted in the top opening and the liquid delivery device is inserted between the adapter and the base element, and the chassis is in unloaded state when the liquid delivery device is not inserted between the adapter and the base element, wherein the displacement of the top element and the displacement of the base element between the loaded state and the unloaded state are small enough to trigger release of the liquid formulation from the liquid delivery device.

14. The chassis of claim 13, wherein the sum of the displacement of the top element and the displacement of the base element between the loaded state and the unloaded state is less than 0.05 mm.

15. The chassis of claim 1, wherein the main frame comprises four penetrating elements, wherein first and second penetrating elements are positioned near the top element, and third and fourth penetrating elements are positioned near the base element.

16. The chassis of claim 1, wherein the top surface of the main frame comprises two strike zones, wherein first strike zone is positioned near the top element, and second strike zone is position near the base element.

17. The chassis of claim 1, wherein the adapter is connected to an injection tool through a tubing.

18. The chassis of claim 1, wherein the penetrating direction is substantially perpendicular to the bottom surface and the top surface of the main frame.

19. The chassis of claim 1, wherein the main frame further comprises one or more side openings, wherein the one or more side openings are configured to receive one or more fastening elements such that the chassis can be fixed onto the plant part with the one or more fastening elements.

20. The chassis of claim 19, wherein the one or more fastening elements are wire, rope, thread, cloth, band, belt, or fiber, or any combination thereof.

21. A plant injection system, comprising:
a fluid delivery device comprising a nozzle and containing a liquid formulation;
a chassis of claim 1, configured to position and mount the fluid delivery device onto a plant part; and
an injection tool, operatively connected to the fluid delivery device and configured to receive the liquid formulation from the fluid delivery device and to release the liquid formulation into the plant part.

22. The plant injection system of claim 21, wherein the fluid delivery device is a pressurized canister.

23. The plant injection system of claim 22, wherein the liquid formulation comprises one or more active ingredients.

24. The plant injection system of claim 21, wherein the injection tool releases the liquid formulation into the active vasculature of the plant part.

25. The plant injection system of claim 21, wherein the system further comprises an adapter for interfacing with the nozzle of the fluid delivery device.

26. The plant injection system of claim 25, wherein the system further comprises a tubing configured to connect to the injection tool on one end and to the adapter on the other end.

27. A method for positioning and mounting a chassis of claim 1 onto a plant part, the method comprising:
positioning the chassis against the plant part; and
exerting a force on the at least one strike zone of the chassis to at least partially insert the at least one penetrating element into the plant part.

28. A method for positioning and mounting a chassis of claim 19 onto a plant part, the method comprising:
positioning the chassis against the plant part; and
fixing the chassis onto the plant part using one or more fastening elements.

29. The method of claim 27, further comprising mounting a fluid delivery device onto the chassis.

30. The method of claim 27, wherein the fluid delivery device comprises a nozzle and contains a liquid formulation, and wherein the method further comprises connecting the adapter inserted in the top opening of the top element of the chassis with the nozzle of the fluid delivery device.

31. A method of using the chassis of claim 1, comprising:
inserting an injection tool into the plant part, wherein the injection tool is connected to one end of a tubing, wherein the other end of the tubing is connected to the adapter;
inserting the adapter in the top opening of the top element of the chassis, thereby forming a light fit between the adapter and the top element of the chassis;
inserting the at least one penetrating element into the plant part; and
inserting the fluid delivery device between the adapter and the base element of the chassis.

32. The method of claim 31, wherein inserting the at least one penetrating element into the plant part comprises striking the at least one strike zone of the chassis with a hammer.

33. The method of claim 31, wherein inserting the fluid delivery device between the adapter and the base element of the chassis comprises connecting the adapter with the nozzle of the fluid delivery device.

34. The method of claim 31, wherein the plant part comprises bark.

35. The method of claim 34, wherein the bark has a thickness of at least 3 mm.

36. A method of using the chassis of claim 19, comprising:
inserting an injection tool into the plant part, wherein the injection tool is connected to one end of a tubing, wherein the other end of the tubing is connected to the adapter;
inserting the adapter in the top opening of the top element of the chassis, thereby forming a light fit between the adapter and the top element of the chassis;
fixing the chassis onto the plant part using the one or more fastening elements; and
inserting the fluid delivery device between the adapter and the base element of the chassis.

37. The method of claim 36, wherein fixing the chassis onto the plant part using the one or more fastening elements comprises passing a wire through the one or more side openings and around the plant part.

38. The method of claim 36, wherein inserting the fluid delivery device between the adapter and the base element of the chassis comprises connecting the adapter with the nozzle of the fluid delivery device.

39. The method of claim 36, wherein the plant part comprises bark.

40. The method of claim 39, wherein the bark has a thickness of less than 3 mm.
